(19) United States
(12) Patent Application Publication
(10) Pub. No.: US 2014/0006973 A1
(43) Pub. Date: Jan. 2, 2014

(54) On-line Collaboration Systems and Methods

(71) Applicant: JADELYNX PTY LTD., Camberwell (AU)

(72) Inventors: James Angus Cattermole, Hawthorn (AU); Jason William McDonald, Fitzroy North (AU); Robert Evan Homewood, Doreen (AU); Yao-Hsing Chiang, Preston (AU)

(73) Assignee: JadeLynx Pty Ltd., Camberwell (AU)

(21) Appl. No.: 13/834,190

(22) Filed: Mar. 15, 2013

Related U.S. Application Data
(60) Provisional application No. 61/666,049, filed on Jun. 29, 2012.

(51) Int. Cl. H04L 29/06

(52) U.S. Cl. CPC H04L 65/40
USPC 715/753

(57) ABSTRACT

Embodiments relate generally to an on-line collaboration system. The system comprises at least one server in communication with multiple client devices over one or more networks, the at least one server executing program code to host an on-line collaborative environment in which users of the client devices can collaborate. The at least one server executes program code to facilitate discussion threads in the on-line collaborative environment and, for each discussion thread, to provide a selectable option to allow proposal of an outcome for the discussion thread.

### RELATED APPLICATION

This application claims priority to U.S. Provisional Patent Application No. 61/666,049, entitled “On-line Collaboration Systems and Methods,” filed on Jun. 29, 2012, the contents of which are incorporated by reference herein in their entirety.

### TECHNICAL FIELD

Described embodiments relate generally to online collaboration systems and methods. In particular, embodiments relate to server-hosted on-line collaborative environments to allow collaboration among multiple users.

### BACKGROUND

Some on-line collaboration systems have been developed in which users within an organisation can conduct collaboration by posting comments and sharing information within various collaborative fora. Some systems allow discussion threads to be developed, which allow users (that have appropriate permissions) to post comments in relation to a topic initiated by one of the users. This effectively allows discussion among the users, to thereby facilitate greater communication among the members of an organisation.

However, it has sometimes been found that with such collaboration systems there can be a great deal of communication that is not productive and, in some instances, can be seen as a drain on employee's productivity. There may also be a perception that such collaboration systems are used as too much of a social forum rather than predominantly a professional forum.

It is desired to address or ameliorate one or more short comings or disadvantages associated with existing on-line collaboration systems, or to at least provide a useful alternative thereto.

### SUMMARY

Some embodiments relate to an on-line collaboration system, comprising:

at least one server in communication with multiple client devices over one or more networks, the at least one server executing program code to host an on-line collaborative environment in which users of the client devices can collaborate;

wherein the at least one server executes program code to facilitate discussion threads in the on-line collaborative environment and, for each discussion thread, to provide a selectable option to allow proposal of an outcome for the discussion thread.

In response to receipt of a proposed outcome, the at least one server or an applet served by the at least one server may execute program code to allow voting selections to be received from client devices in relation to the proposed outcome. The voting selections may consist of a positive vote selection and a negative vote selection. The at least one server or an applet served by the at least one server may execute further code to display the number of positive vote selections received and the number of negative vote selections received in relation to the proposed outcome. The at least one server or an applet served by the at least one server may execute further program code to allow receipt of an acceptance selection or a rejection selection in relation to a proposed outcome.

The at least one server may have access to stored user permission data specifying a permission level for each user in relation to the proposed outcome, wherein the at least one server may allow receipt of the acceptance selection or the rejection selection in relation to the proposed outcome only when the acceptance or rejection selection is received from a client device or user account authenticated with an appropriate permission level.

The at least one server may execute further code to display a current outcome status for each proposed outcome. The current outcome status may consist of a pending status and a closed status. The closed status may consist of an accepted status and a rejected status.

The at least one server may execute further code to cause the display on each client device of a list of proposed outcomes for a user group to which a user of the client device belongs.

Some embodiments relate to a method in an on-line collaborative environment, the method comprising:

hosting at least one discussion thread; and

providing a selectable option to allow proposal of an outcome for the at least one discussion thread.

The method may further comprise, in response to receipt of a proposed outcome, allowing voting selections to be received from client devices in relation to the proposed outcome. The voting selections may consist of a positive vote selection and a negative vote selection. The method may further comprise serving code to display the number of positive vote selections received and the number of negative vote selections received in relation to the proposed outcome. The method may further comprise serving code to allow receipt of an acceptance selection or a rejection selection in relation to a proposed outcome.

The method may further comprise allowing receipt of the acceptance selection or the rejection selection in relation to the proposed outcome only when the acceptance or rejection selection is received from a client device authenticated with an appropriate permission level.

The method may further comprise serving code to display a current outcome status for each proposed outcome. The current outcome status may consist of a pending status and a closed status. The closed status may consist of an accepted status and a rejected status.

The method may further comprise serving code to display on each client device a list of proposed outcomes for a user group to which a user of the client device belongs.

Some embodiments relate to a server-hosted on-line collaborative environment that allows proposed discussion outcomes to be received and posted in response to receipt of an outcome proposal selection.

Some embodiments relate to a method for on-line collaboration, comprising:

allowing selection of an option to propose an outcome in relation to a discussion thread.

The method may further comprise, in response to selection of the option to propose an outcome, serving code to display an outcome proposal window that allows preparation and submission of an outcome proposal. The method may further comprise, in response to receiving an outcome proposal, serving code to display the outcome proposal in relation to the discussion thread. The displayed outcome proposal may include selectable voting options to reject or accept the proposed outcome.

The method may further comprise, in response to receiving selections of the selectable voting options, recording the selections in a data store and, in a subsequent display of the outcome proposal, displaying an indication of a number of acceptance selections and rejection selections received in relation to the outcome proposal.

The discussion thread may include at least one discussion post and a discussion header.

The method may further comprise serving code to display to only an authorised user a selectable option to accept or reject the outcome proposal. The method may further comprise, in response to receipt of a selection to accept the outcome proposal, posting the accepted outcome in relation to the discussion thread and disallowing further discussion posts in relation to the discussion thread. The method may further comprise, in response to receipt of a selection to reject the outcome proposal, posting the rejected outcome in relation to the discussion thread and allowing further discussion posts in relation to the discussion thread.

Some embodiments relate to a method of on-line collaboration, comprising:

allowing a discussion thread to be initiated by a member of a group of users;

allowing proposal of an outcome of the discussion; and

sending a prompt to at least one member of the group to propose an outcome of the discussion if an outcome has not been proposed within a set time.

The set time may be a time elapsed since a most recent post in the discussion thread. Alternatively, the set time is a time elapsed since initiation of the discussion thread. The prompt may be sent to all members of the group or just to the topic creator, the group owner and one or more moderators of the group.

Proposal of an outcome of the discussion may only be permitted to be made by one or more authorised members of the group. The group may be a sub-group of the users participating in the on-line collaboration.

Some embodiments relate to a method of on-line collaboration, comprising:

allowing proposal of an outcome of a discussion thread, the discussion thread being accessible to a defined group of users;

receiving a voting selection made by each member of the defined group of users in relation to a proposed outcome.

The method may further comprise serving code to display a selectable positive voting option and a selectable negative voting selection. The method may further comprise serving code to display the proposed outcome at a head of the discussion thread.

The method may further comprise serving code to display a current vote count in relation to the proposed outcome, the vote count representing the number of voting selections received in relation to the proposed outcome. The vote count may comprise a positive vote count and a negative vote count corresponding to receiving positive voting selections and negative voting selections. The method may further comprise receiving a rejection selection or an acceptance selection in relation to the proposed outcome.

Each discussion thread may be hosted in relation to a member group, the member group being a subset of all members participating in the on-line collaborative environment. Only authorised members of each member group may be permitted to select the selectable option to allow proposal of the outcome.

The method may further comprise, for each member of a member group, recording all contributions of the member in relation to the at least one discussion thread. Each member may be eligible to participate in multiple member groups of a specified group type.

The method may further comprise allowing acceptance or rejection of the proposed outcome for each at least one discussion thread and recording in a data store all posts and votes received from group members in relation to the proposed outcome.

The method may further comprise, for an accepted outcome, requesting feedback on the outcome from contributors to the discussion thread in relation to which the outcome was accepted, wherein the requesting feedback is performed within the on-line collaborative environment after a predetermined period from when the outcome was accepted.

The requesting feedback may comprise requesting an indication of whether the outcome was a good outcome or a bad outcome. The method may further comprise determining metrics of a decision-making effectiveness for each group member. The method may further comprise determining metrics of a decision-making effectiveness for each member group. The method may further comprise determining metrics of a decision-making effectiveness across all members participating in the on-line collaborative environment.

Some embodiments relate to computer-readable storage storing executable program code to perform or enable performance of the methods described above or to implement the systems described above or to implement the described collaboration environment.

Some embodiments relate to a system comprising means for performing or enabling performance of the methods described above or to implement the systems described above or to implement the described collaboration environment.

### BRIEF DESCRIPTION OF THE DRAWINGS

Embodiments are described in further detail below, by way of example and with reference to the accompanying drawings, in which:

FIG. 1 is a block diagram of an on-line collaboration system;

FIG. 2 is a block diagram of a client and a server of the on-line collaboration system, showing functional modules of the client and server in further detail;

FIG. 3 is a block diagram showing functional components of the server-hosted on-line collaboration environment in further detail;

FIG. 4 is a diagram of entity relationships within the on-line collaboration environment;

FIG. 5 is a flowchart of a method of facilitating discussion outcomes in an on-line collaborative environment;

FIG. 6 is a flowchart of a method of facilitating resolution of an outcome in an on-line collaborative environment;

FIG. 7 is an example display of a discussion thread in an on-line collaborative environment;

FIG. 8 is an example display of an outcome proposal window of a discussion thread in an on-line collaborative environment;

FIG. 9 is an example display of a proposed outcome of a discussion thread in an on-line collaborative environment;

FIG. 10 is an example display of an approved outcome of a discussion thread in an on-line collaborative environment;

FIG. 11 is an example display of a topic list for a group in an on-line collaborative environment;

FIG. 12 is an example display of a discussion thread in an on-line collaborative environment, including a rejected proposed outcome;

FIG. 13 is an example display of a topic list showing outcome statuses of discussion threads in an on-line collaborative environment;

FIG. 14 is an example display of an outcome browsing page in an on-line collaborative environment;

FIG. 15 is an example display of a group home page in an on-line collaborative environment;

FIG. 16 is an example display of a decision analytics page indicating how users participating in the on-line collaborative environment may be ranked among other users in terms of their decision-making; and

FIG. 17 is an example display of a decision history of a user participating in the on-line collaborative environment.

### DETAILED DESCRIPTION

Described embodiments relate generally to online collaboration systems and methods. In particular, embodiments relate to server-hosted on-line collaborative environments to allow collaboration among multiple users. Such on-line collaborative environments are intended to allow and facilitate a kind of enterprise collaborative social networking that aims to promote the needs and goals of the enterprise, as distinct from public social networking such as is provided by Facebook™ or Twitter™, which is unstructured and unaligned with any organisational purpose.

Described embodiments generally involve provisions to propose an outcome in relation to a discussion thread. Such a proposed outcome may be generated by user selection of an option displayed in relation to the discussion thread, providing that the user selecting the “propose outcome” option has the appropriate user permission to do so. Although the term “outcome” is used herein, this should also be understood to include a resolution, decision, judgement, conclusion, agreement or action item that can be agreed upon in relation to a topic or discussion. The purpose of such features and functions is to promote greater productivity from discussions conducted by group members, so that an organisation providing, hosting or using the on-line collaboration environment can realise greater benefit from the group members' interaction. While it is possible to interface the production of outcomes with other systems, such as project management systems, that allow task allocation to group or team members, the described embodiments are primarily concerned with facilitating the proposal and resolution of outcomes in relation to discussion threads/topics within an on-line collaboration environment.

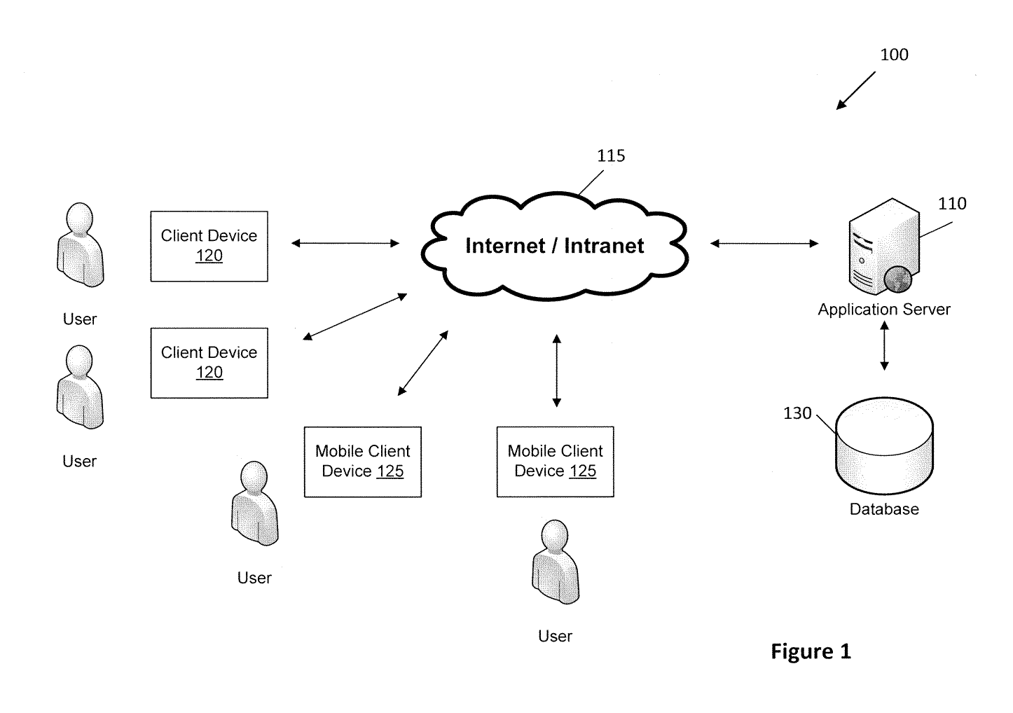

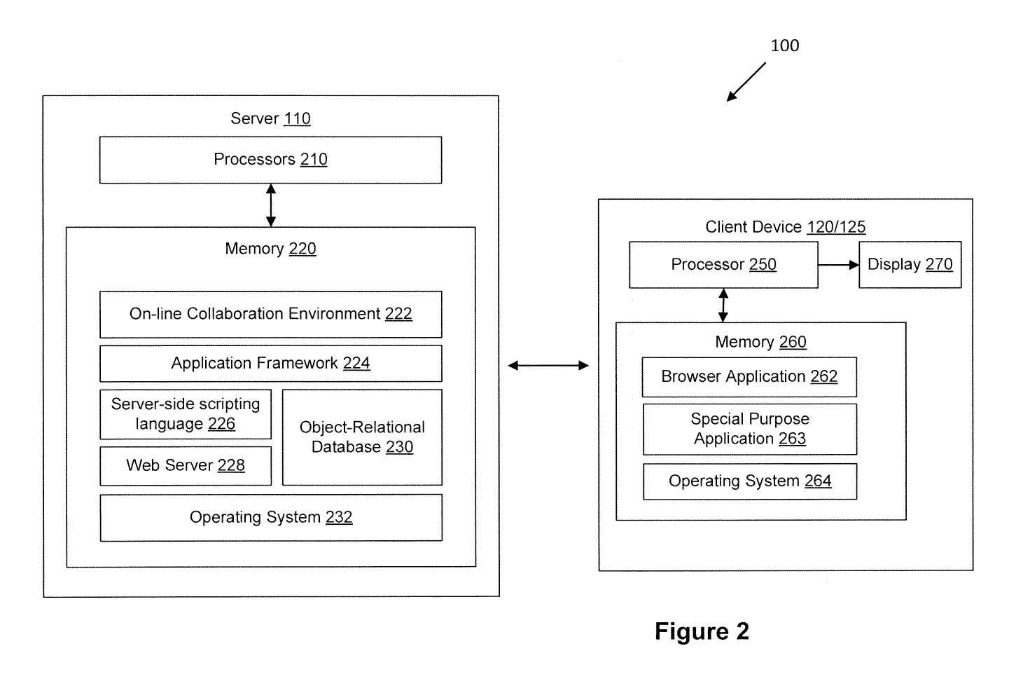

Referring generally to FIG. 1, a system 100 for facilitating on-line collaboration is described in further detail. Aspects of system 100 are also shown and described by way of example with reference to FIGS. 2, 3 and 4. System 100 comprises a server system 110 and multiple client computing devices 120, 125 in communication with each other over a network 115, such as a local area network, a wireless data network, an intranet or the Internet or a combination of a number of such networks. System 100 further comprises a database 130 accessible to server system 110 for storing data pertinent to operation of server system 110 and provision of service to client computing devices 120, 125.

Client computing devices 120, 125 may comprise a desktop 120 or a mobile or handheld computing device 125 having at least one processor 250, one or more forms of memory 260, an operating system 264 and a user interface including a browser application 262 operable by a user. The memory may comprise volatile (e.g. RAM) and non-volatile (e.g. hard disk drive, solid state drive, flash memory and/or optical disc) storage. The user interface may comprise a display 270 and at least one input device, such as a touch-screen, a keyboard, mouse, stylus or other peripheral device that can be used for providing user input to client computing devices 120, 125.

A number of software applications or applets may be executing or executable by the at least one processor 250 to perform various device-related functions. Such applications may be stored in the non-volatile memory 260 of computing device 120, 125. At least one such software application includes the browser application 262 for enabling a user to navigate to sites accessible over the network 115 to receive content therefrom. Other client software applications may execute on client devices 120, 125 using operating system 232.

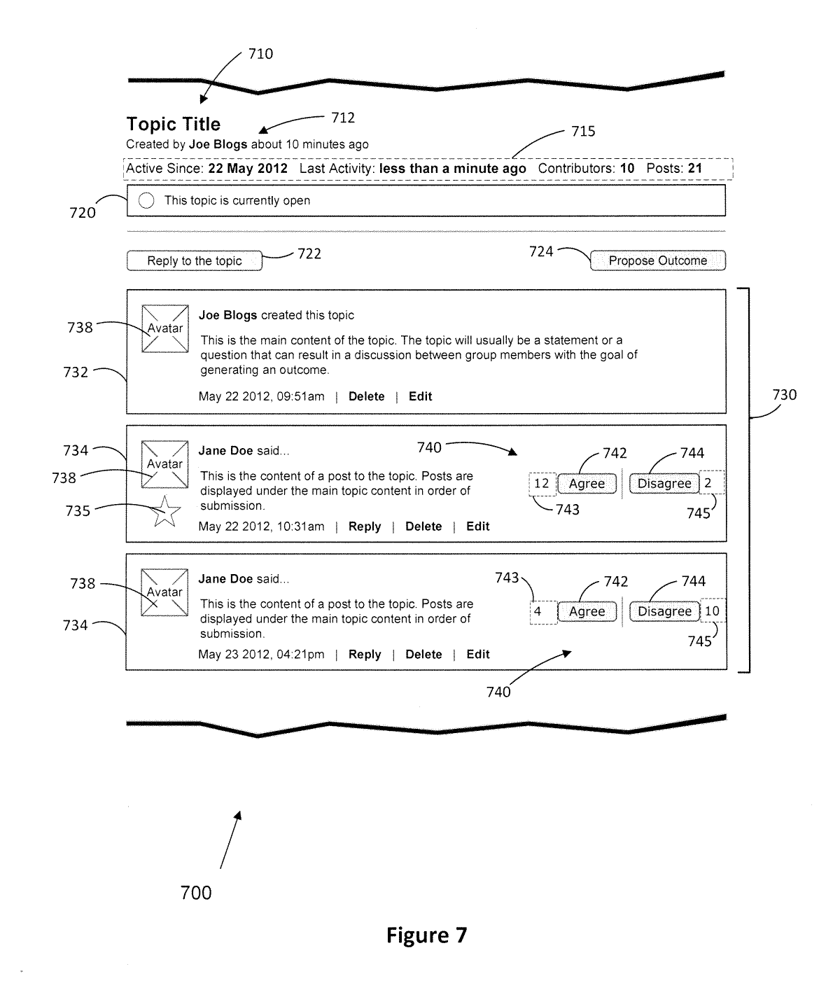

In the example of system 100 illustrated in FIGS. 1 and 2, client browser application 262 can be used to communicate with server system 110 to request content therefrom, in the form of one or more web pages provided as program code executable by the browser application 262. According to some embodiments, server system 110 is configured to serve code to provide an on-line collaboration environment for a user viewing a display generated by browser application 262 and viewable on display 270. Thus, server system 110 can be considered to act as an on-line collaboration system or to act as a host for such a system. FIGS. 7 to 17 are described in further detail below and illustrate example displays of pages displayable by browser application 262 according to code received from server system 110.

In some embodiments, the browser application 262 may be supplemented by a special-purpose add-on or may be substituted by special-purpose client software (i.e. an “app” for a smart-phone or tablet device) in order to perform the functions described herein or to facilitate such functions. For example, for mobile client computing devices 125, a special purpose application 263 may be downloaded from the server 110 or a separate dedicated download server (not shown) and installed on the mobile client computing devices 125. When such a special purpose application 263 is executing on the mobile client computing devices 125, it may facilitate appropriate formatting, interaction, display and input to enable the user interface functionality described herein. In this way, the special-purpose application 263 cooperates with the server system 110 to provide access to and participation in the on-line collaboration environment 222 (FIG. 2) in a manner akin to the Facebook™ or LinkedIn™ “apps” currently available for tablet computing devices and smart phones.

For simplicity of illustration, the server system 110 is generally described herein as serving code or one or more applets to the client computing devices 120 and 125 to perform some of the described user interface functions. However, it should be understood that this includes the server system 110 transmitting code and/or data to (and receiving code and/or data from) a special purpose application 263 executing on a client computing device 125 to enable that special purpose application 263 to provide the necessary or appropriate displays and interactive features (e.g. display of input fields, voting buttons, messaging and notifications, selectable options, etc.) described herein.

Server system 110 comprises at least one processing device 210, and may comprise multiple processing devices or multiple virtual or physical servers operating in cooperation and/or parallel to operate web server functions 228 (e.g. using a hypertext transfer protocol daemon (HTTP)), data processing functions and data storage and retrieval functions (e.g. using structured query language (SQL) support, such as object-relational database functions 230) in conjunction with database 130. Server system 110 may also comprise scripting language support 226, such as Microsoft™ ASP, ASP.NET, Java/J2EE or PHP. Server system 110 may comprise or have access to suitable non-volatile data storage separate to database 130 for storing executable program code to enable server system 110 to perform its functions, including those functions described herein. Such program code comprises an operating system 232 and an on-line collaboration environment 222 supported by a suitable application framework 224, such as Symfony (for PHP).

Database 130 may comprise a localised or distributed database storing data records for the various user accounts, discussion threads (also called discussion topics), outcomes, files, permissions, etc. The time and date of user voting feedback received, for example in the form of positive or negative votes regarding a user post of a proposed outcome, is also stored in database 130. Database 130 and/or object-relational database 230 stores all or almost all user activity data, as well as group activity data and statistics or metrics derived or determined from such data.

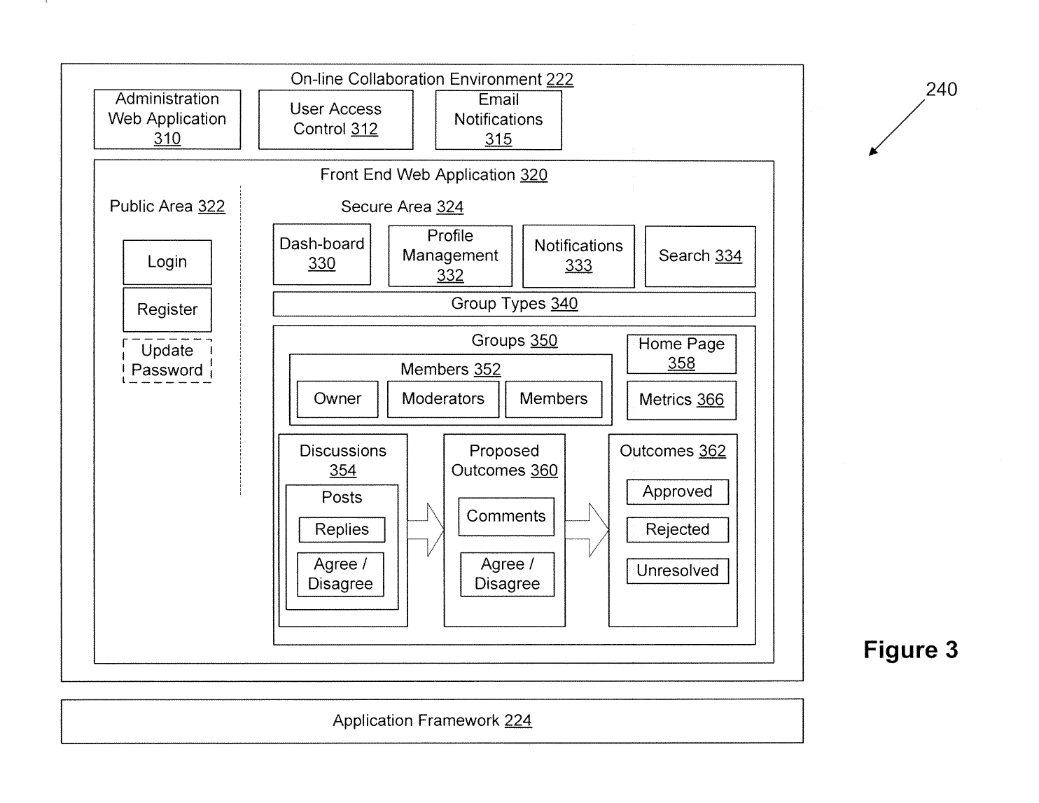

Referring in particular to FIG. 3, a server-side application architecture of the on-line collaboration environment 222 is now described in further detail. The on-line collaboration environment 222 generally comprises executable code modules that, when aggregated and executed by the one or more processors 210, perform programmed functions as described herein. Such functions include provision of an administration web application 310, a user access control function 312, a notification function 315 and front end web application functions 320, for example.

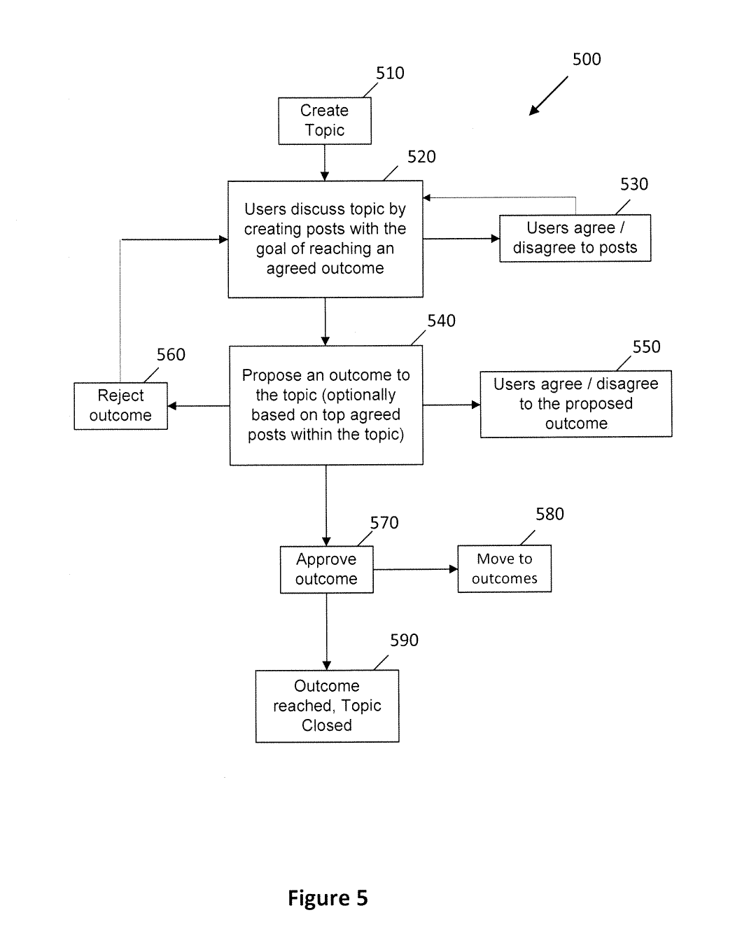

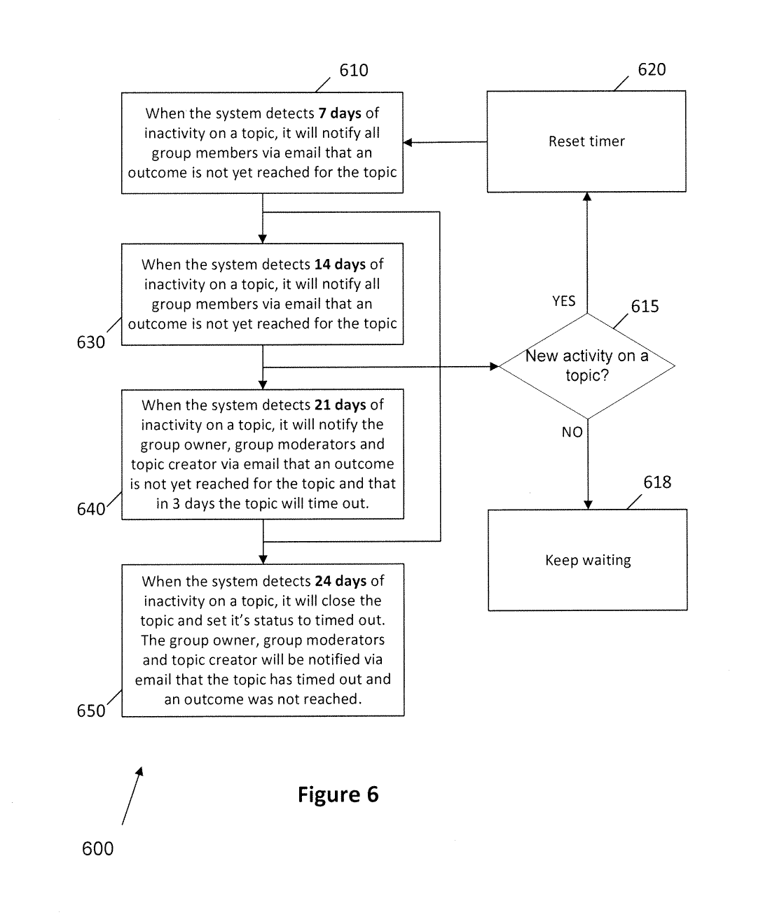

The front web application functions 320 include functions divided into a public area 322, such as user login, registration and password updating, and a secure area 324, where the on-line user discussion and interaction occurs. The secure area 324 includes functions related to activity feed 330, user profile management 332, notifications 333, searching 334, management of group types 340 and management of groups 350. The group functions 350 are concerned with group members 352 (which are generally a subset of the users and include members who also have rules as owner or moderator of a group), discussions 354, a group home page 358, a metrics module 366, proposed outcomes 360 and outcomes 362 that are approved, rejected or unresolved. The operation of these functions are further described and/or evident from the flowcharts in FIGS. 5 and 6 and example displays shown in FIGS. 7 to 17 in conjunction with the accompanying description of those Figures.

When supported by and combined with the application framework 224, and the other server-side functions described previously, the on-line collaboration environment 222 acts as an on-line collaboration system 240. In some embodiments, this on-line collaboration system 240 may encompass activities that can be viewed as being performed or executed at the client computing devices 120, 125. However, it is to be emphasised that the activities performed or executed at the client computing devices are reliant on program code (including applets, where appropriate) served by server system 110 to the client computing devices 120, 125 and executed by the browser application 262 or the special purpose application 263. The functionality of the system 100 is therefore driven by code executed and served by the server system 110.

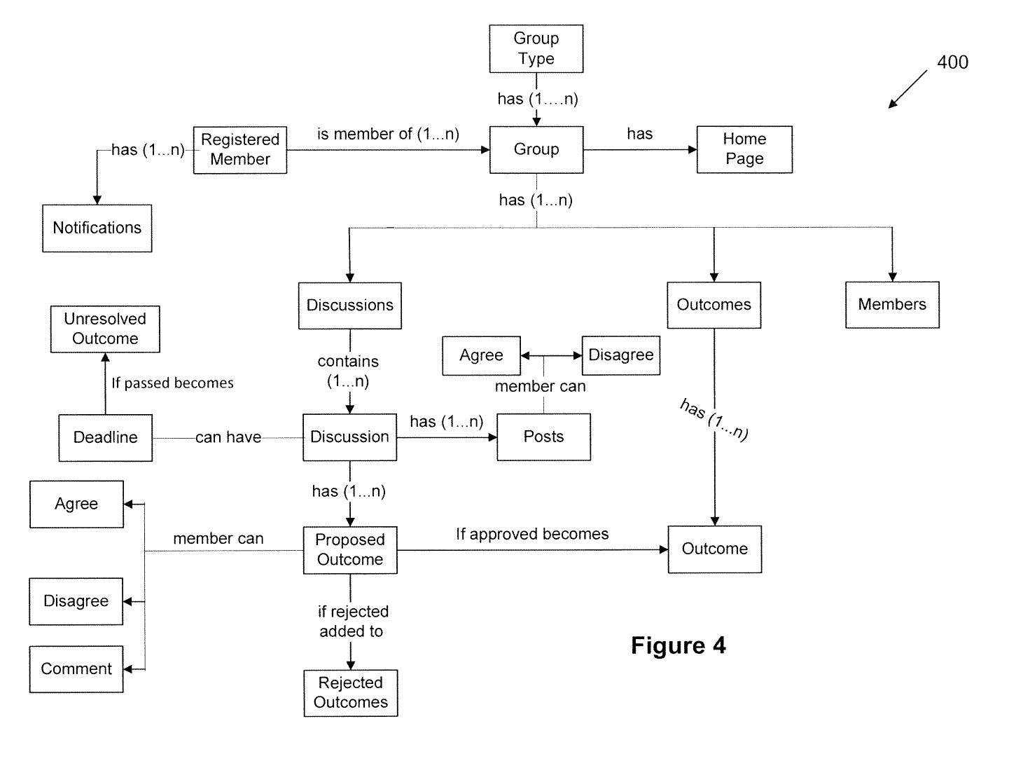

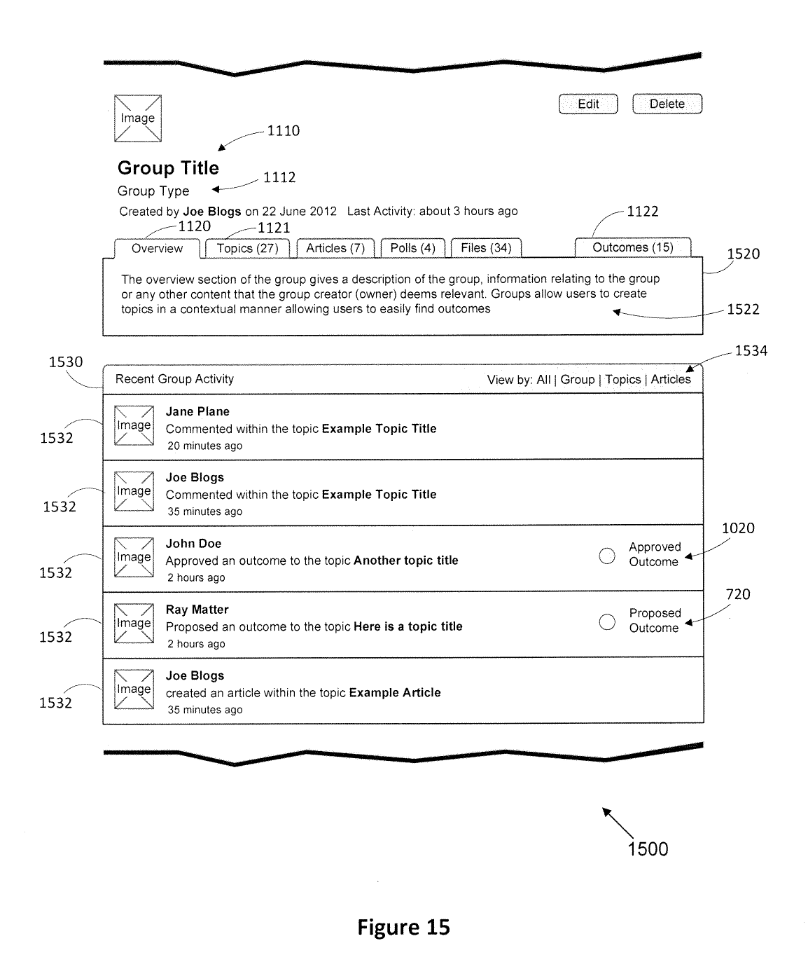

Referring also to FIG. 4, there is shown a diagrammatic representation of the relationships among entities in the on-line collaboration environment 222. Generally, each of the many registered users participating as members 352 in the on-line collaboration environment 222 will belong to at least one group 350 of users. Each member receives one or more notifications on a periodic basis and/or triggered by events occurring in the environment. The groups 350 are divided into different group types and may be configurable by authorised (super) users to relate to different personnel groups within an organisation. Such groups may be formed on the basis of role, geographic location or region or sub-region, business function or alignment or on a project basis, for example. Different group types may each have multiple groups. Each group has at least one member but members may be part of more than one group. Each group has a home page 358, an example of which is shown in example display 1500 in FIG. 15, to allow members of that group to easily check into the group and see the latest group activity and participate in relevant discussions 354 and proposed outcomes 360.

User groups may be generally closed groups, in the sense that the general public cannot join such groups and only authorised users, who will commonly be employees of the organisation, enterprise or company sponsoring and providing the on-line collaborative environment, can join user groups. Even then, each user wishing to participate in a user group may need to be appointed or admitted to the group by a super user.

Each group may have one or more topics (also called discussions) posted as discrete discussion threads and may have one or more outcomes. The group can have multiple group outcomes arising from the various discussion threads of the group that resulted in an accepted or approved outcome. In some embodiments, each topic can only have one accepted outcome. In other embodiments, a topic can have more than one accepted outcome. Each group may also have one or more articles posted or linked to it, may have one or more polls and may have one or more files posted or linked to it.

Each discussion can have multiple posts, which together form a discussion thread, and is initiated by a group member that starts the discussion thread with an initial post. This initial post generally remains at the top (or head) of the thread and serves as an introduction to the discussion. Each member can add further posts to the discussion or replies to other posts. Each member can agree or disagree with each post only once. Optionally, instead of a yes or no vote, members may be able to indicate a relative degree of agreement or disagreement with a post, such as by indicating a selection along a scale, like “strongly agree”, “agree”, “neutral”, “disagree” or “strongly disagree”, which may be correlated with a numerical score from say 1 to 5 or 1 to 10, for example. The relative degree of agreement or disagreement may be reflected in a numerical sum of weighted positive and negative votes, for example, such that a “strongly agree” positive vote would be given more weight than an “agree” positive vote and a “strongly disagree” negative vote would be given more weight than a “disagree” negative vote. This numerical sum may be displayed instead of or in addition to a display of the total number of votes. Optionally, group members cannot agree or disagree with the initial post. Each discussion may have a deadline (optionally set by the topic creator or group moderator) for proposing or resolving an outcome. If the deadline is passed without an outcome being proposed or resolved (rejected or approved), then the discussion (or proposed but unresolved outcome) may be recorded as unresolved.

For each proposed outcome, each group member of the group to which the relevant discussion belongs can agree, disagree (ie vote) or comment on the proposed outcome. Optionally, instead of a yes or no vote, members may be able to indicate a relative degree of agreement or disagreement with a proposed outcome, such as by indicating a selection along a scale, like “strongly agree”, “agree”, “neutral”, “disagree” or “strongly disagree”, which may be correlated with a numerical score from say 1 to 5 or 1 to 10, for example. The relative degree of agreement or disagreement may be reflected in a numerical sum of weighted positive and negative votes for the proposed outcome. This numerical sum may be displayed instead of or in addition to a display of the total number of votes for the proposed outcome.

Each discussion may have one or more proposed outcomes, but only one outcome can be accepted as the outcome of the topic/discussion thread. If a proposed outcome is approved/accepted by an authorised user (i.e. a creator of the topic, a moderator or a group owner), then it becomes recorded as an outcome, decision, conclusion, judgement or formal resolution of the discussion thread and attributed as an outcome for the group. This approved outcome forms part of a knowledge base or repository for the entire on-line collaboration environment. As an outcome is approved, it is automatically stored and indexed in a master knowledge base (as part of object-relational database 230) searchable by members of the on-line collaboration environment so that all of the users of the system can view/access the decided outcomes.

The discussion thread is closed once the outcome is accepted, such that members are disallowed from making any further posts to the discussion thread. Non-authorised members cannot accept or reject a proposed outcome, so such options are not displayed to such members. If the proposed outcome is rejected, then it is recorded as a rejected outcome for auditing purposes and remains embedded in the (still open) discussion thread for historical reference so that an improved outcome proposal can be made. Each member can agree or disagree with each proposed outcome only once.

Server system 110 creates and maintains records of all outcomes created within the context of group discussions, whether those outcomes are proposed, resolved or unresolved. Additionally, server system 110 records data concerning how and in what context the outcomes are resolved or unresolved and whether or not the outcomes are resolved within a specified deadline (if such a deadline is specified as a default configuration or by the user proposing the outcome). For example, server system 110 records how many group members participated in the decision making process (ie, by voting, posting or commenting) that led (or did not lead) to the resolution of the outcome. Server system 110 determines statistics and metrics regarding the level of agreement among group members (ie, a proportion of those who agree versus those who disagree), as well as the size of the group, the frequency of discussion posts and the time period within which the outcome was resolved, if at all.

Following the approval of an outcome, server system 110 may, within one or more configured periods after the date of acceptance of the outcome, prompt group members that participated in the discussion to which the outcome related (ie, by voting on the proposed outcome, posting to the discussion or voting on posts) to provide feedback about the apparent effectiveness and success of the outcome. Group members may also be prompted by server system 110 (ie, by transmission and notifications 333 within the front end web application 320 or possibly by email notifications 315 transmitted to an external email address) to review and comment on the feedback information given by other users. Thus, with the benefit of hindsight, group members can provide further information, for example, by commentary and/or voting, to enable server system 110 to determine an apparent effectiveness and success of the outcome. This information can be useful for business leaders to gauge the productiveness of the decision making of various groups and their group members. In this way, the server system 110 can generate information and reports to identify whether or not certain groups are making good or bad decisions, based on feedback information received and collated in relation to the various outcomes associated with such group discussions.

Whether or not an outcome is to be the subject of a request by server system 110 to the group members for feedback is configured by the proposer of the outcome either at creation of the proposed outcome or at resolution of the outcome. Where an outcome is configured to be subject to feedback after it is resolved, contributing group members may receive a notification setting a feedback response period, such as several days, and then will receive a further notification on the day when the feedback response is due. If no feedback contribution is made by a given group member after such notifications, the group member may be further prompted to provide such feedback, either by voting or commenting, for example.

The metrics thus determined in relation to outcomes are used by metrics module 366 of the server system 110 to ranking/analysing the apparent quality or effectiveness of an outcome. This information can be aggregated and ranked/analysed for outcomes generated by each individual member, each member group, each type of group and the organisation as a whole. Additionally, the ranking and analysis of the quality of decisions can be determined by the metrics module 366 for various sets of members or groups sharing certain characteristics, such as groups within a certain business division, members having a certain experience level, members having a certain role within the organisation, etc. This allows an organisation sponsoring or providing the on-line collaboration environment 222 to its employees to set key performance indicators (KPIs) around quantity and quality of outcomes/decisions for certain groups and as an organisation.

Referring now to FIGS. 5 and 7 to 10, a method 500 of facilitating discussion outcomes is described in further detail. Method 500 is facilitated by server system 110 based on code served by server system 110 to one or more client computing devices 120, 125. Therefore the acts described in relation to method 500 are performed by execution in browser application 262 of browser-executable code served to the client computing device 120, 125 by server system 110. Method 500 begins at act 510, when a group member creates a topic using a selectable option, such as by clicking on a button that is labelled “create topic” on a home page of the group. This creates an initial post 732 and a header area is created for the discussion topic. This header area may include a topic title 710, information 712 about the topic creator and the time of creation, plus further information 715 about group activity on the topic and the number of posts and the number of contributors to the topic. Each member that posts to the topic has the member's user name, and optionally also an avatar or photo 738 of the user, appear adjacent the post. At 520, one or more users discuss the topic by contributing posts (using user-selectable options, such as a button 722 labelled “Reply”, that allow a reply to be posted to the initial post 732 or to subsequent posts 734), thereby creating one or a series of posts constituting a discussion thread 730, with the aim of reaching an agreed outcome.

At 530, as part of the discussion occurring during 520, group members may vote (agree or disagree or indicate a relative level of agreement or disagreement, depending on what selectable options are provided) on each post by clicking a corresponding positive or negative voting button/selection 742/744 displayed in association with each post. The number of positive (743) and negative (745) votes for each post is displayed adjacent the corresponding voting button 742, 744. The voting buttons 742, 743 and vote tallies 743, 745 may be presented within a feedback section 740 of a defined and demarcated post area. Feedback section 740 (or another section within the demarcated post area) may also comprise a selectable link or button to edit or reply to previously posted user comments in relation to a discussion post and allow authorised users to delete the post. Whether the voting is a yes or no vote or a relative agreement or disagreement indication, the user's input must be received by making a selection, rather than by writing text, such as writing the word “yes”, in an input field.

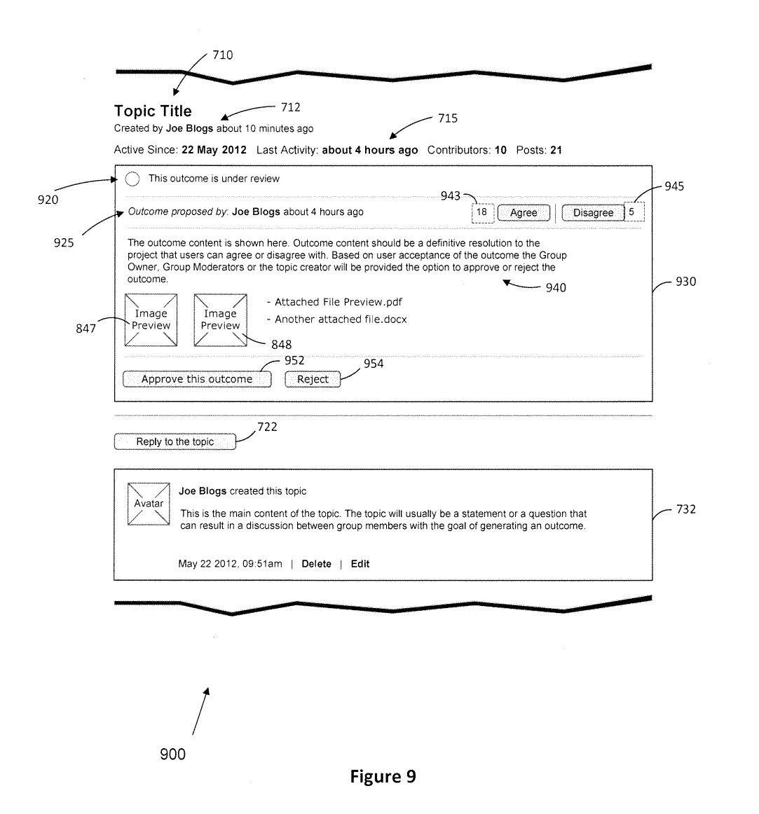

Selection of a positive or negative (or other) voting button 742, 744 (or 942, 944 in FIG. 9) triggers the code executing in browser application 262 to transmit a message to server system 110 indicating the Boolean status of the vote (yes/positive or no/negative) (or relative scale indication in some embodiments), the user casting the vote, the time and date and an identification of the post that is the subject of the voting feedback. Instead of the feedback message comprising the time and date of the vote, server system 110 may record the time and date at which the feedback message is received at the server system 110. Server system 110 then records all of the voting information received in such messages as voting data in database 130 and/or object-relational database 230.

Posts that receive a high proportion of positive to negative votes or relative approval or disapproval scores may be highlighted within the discussion thread, such as by the display of a marker 735 or by visually emphasising the particular post relative to other posts. This visual emphasis may involve showing the high-approval post in a different colour or with a different border or by associating it with symbols, such as stars or exclamation marks, by way of non-limiting examples. Posts thus attracting a high degree of positive votes can then be more easily discerned by a member who is preparing to propose an outcome and wishes to quickly get an appreciation of the general sentiment of the group members

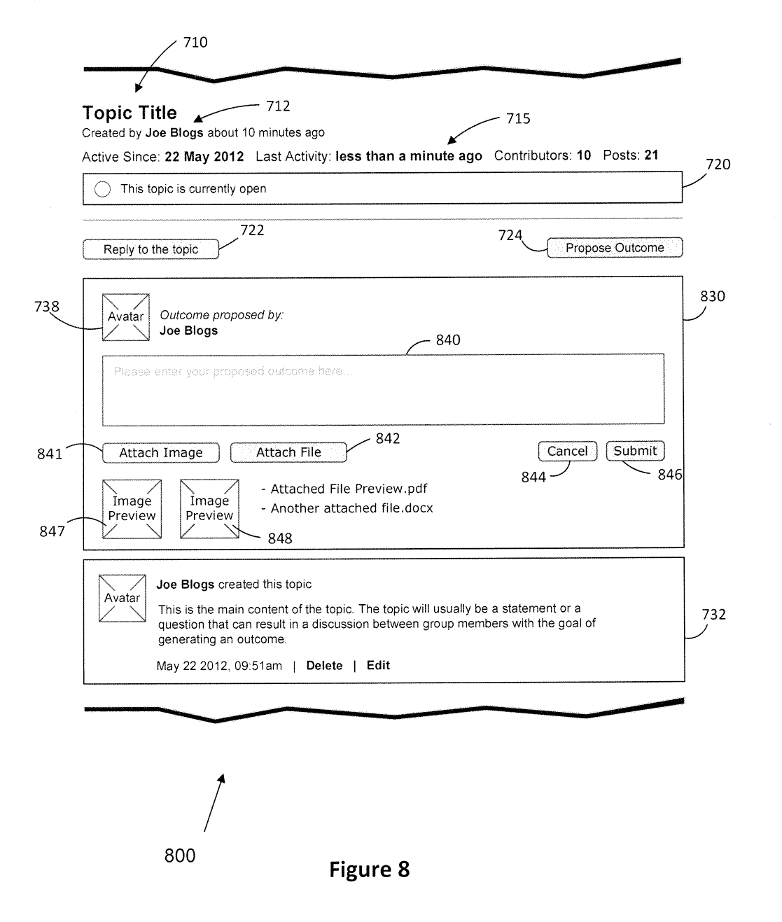

At 540, an authorized member of the group can propose an outcome by selecting a selectable option to do so, such as by clicking a button 724 labelled “propose outcome” or other descriptive wording to a similar effect. Selection of the propose outcome option 724 triggers the script executed by the browser application 262 that is generating display 700 to either request further page code from the server system 110 or to execute an applet within that script to display an outcome proposal window 830, as shown in display 800 of FIG. 8. The outcome window 830 includes details of the proposing member and optionally that member's avatar, plus an input field 840 to receive a written description of the proposed outcome in the form of text. The outcome proposer may also attach images or files by selecting corresponding attachment options 841, 842 and these can be shown by a thumbnail preview 847, 848. Once the proposing member has composed the text that will form the proposed outcome, the member may select a submit option/button 846 or alternatively, the outcome proposal can be cancelled (and window 830 hidden) by selection of a cancel option/button 844. If the submit option 846 is selected, then an applet or the server system 110 checks that outcome content (usually text) has been entered into field 840. If the proposed outcome is thus validated, then all attachments are saved to the data store 130,230. Outcomes can only be proposed in relation to open topics.

In some embodiments, the input field 840 may be pre-populated with one or more posts that had the highest number of positive votes and/or the highest proportion of positive to negative votes (which may be subject to threshold levels in numbers of votes to avoid posts with low numbers of votes being overvalued). The proposer can then choose to use the text of such well-regarded posts or discard that text in formulating the proposed outcome. It is generally envisioned that leaders within a group or organisation will be those members that are authorised to create and decide (accept/reject) outcomes.

System 110 may optionally determine various metrics relating to the effectiveness (or lack thereof) of each group member's participation in the online collaboration environment 222. For example, for each group member, system 110 may record in the object relational database 230 all information regarding activity a group member has in relation to each discussion and outcome. Such information may include one or more of, but is not limited to, the following:

the number of contributions from the group member;

the number and ratio of agrees (or yes votes) or disagrees (or no votes) to the contributions that the group member has made;

the number of outcomes proposed by the group member;

the number and ratio of agrees and disagrees recorded against the proposed outcome;

the number of outcomes proposed that were accepted/approved;

the number of outcomes proposed that were rejected;

the number of agrees and disagrees the group member has made in relation to other group member comments and the consistency of those comments with other group members (ie, where the group member agreed to an outcome but a large number of other group members disagreed with the outcome);

the number of agrees and disagrees the group member has made in relation to a proposed outcome and the consistency of those votes with the votes of other group members;

the number of comments (posts) made in relation to proposed outcomes;

the number of outcomes the group member was involved in that were approved by an outcome deadline or after the deadline (if a deadline was set);

the number of outcomes within groups that the group member was part of that were agreed but which the group member did not contribute to; and

the number of outcomes the group member was involved in that timed out or were otherwise unresolved, whether or not the user contributed to the proposed outcome.

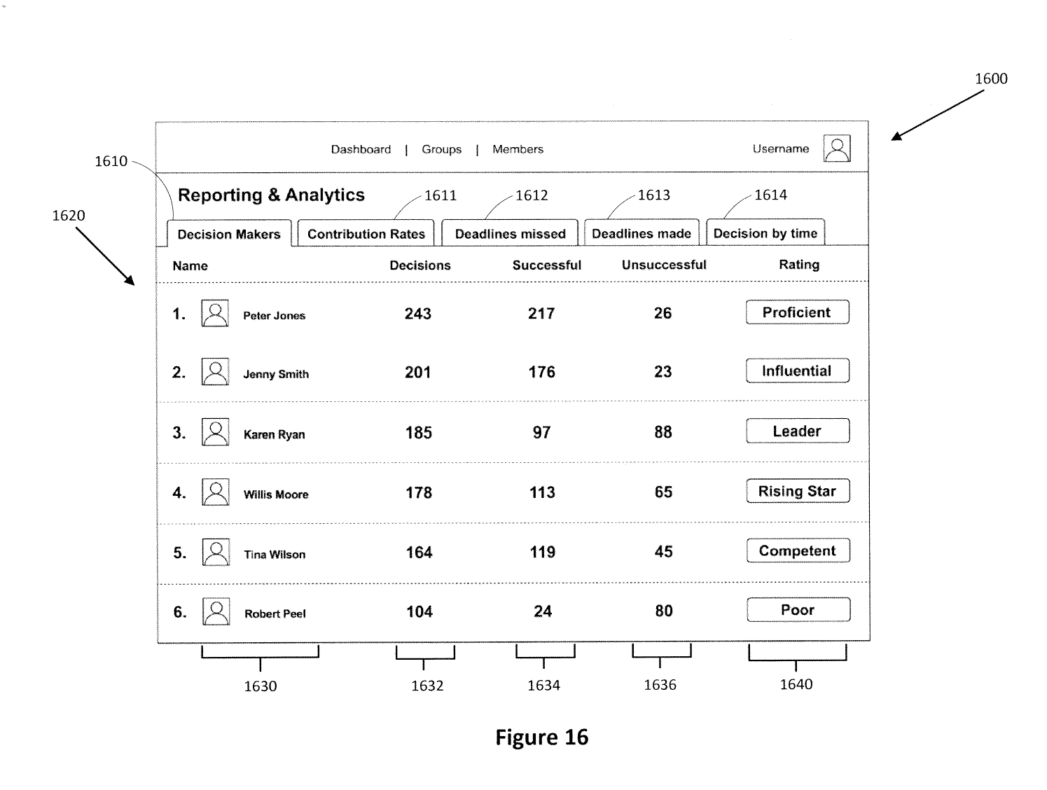

Some or all of the information described above may be used, together with determined metrics of recorded outcomes, to identify how a particular group member is performing as a contributor and decision maker. Such information is used by a metrics module 366 of server system 100 to determine a rating, ranking and/or waiting of the decision making effectiveness and/or influence of each member. An example display of a ranked member list is shown in FIG. 16 and described in further detail below.

An effectiveness rating of a member, once determined, can be displayed in relation to such a member. For example, wherever the group member's name, avatar or thumb nail picture is displayed adjacent a contribution from that member, as the high rating may be indicated by displaying a graphical emphasis in relation to the member's identification indicia (avatar, name and/or picture). Where the particular member has a high rating as an effective decision maker, contributions by that member may be weighted more highly than contributions of other group members with a lesser rating. For example, a highly rated group member may have a contribution weighting of a higher value (ie, 30% greater, for example) compared to the weighting of a member with a lesser rating. This higher weighting may be taken into account when determining the results of votes received in relation to a discussion post or proposed outcome or in displaying posts in order of likely or apparent influence value.

As a further example, a member with a high rating that agrees to a proposed outcome may have more bearing on the result of the outcome being approved or rejected than a member with a poor rating. Server system 110 advantageously displays or draws attention to members with high ratings, so that other group members can easily reference the contributions of highly rated members and take such members' views into account when proposing a new decision. Further, wherever code is executed to allow a new decision to be formulated (as it is shown and described in relation to FIG. 8, for example), server system 110 may serve code or serve an applet to provide highlighted contributions from highly rated group members disposed or selectively viewable (ie, by mouse over or option selection) adjacent the proposed outcome description input field 840.

Once an outcome is proposed at 540, an outcome display 930 is generated (see display 900 in FIG. 9) in an emphasised or demarcated section positioned at the top of the discussion thread. The outcome display 930 includes the text that was input into field 840 as the text 940 of the proposed outcome. Members have the option to vote in favour or against the proposed outcome at 550 using positive and negative voting selections 942, 944. The number of positive (943) and negative (945) votes received is displayed in proximity to the proposed outcome within the demarcated section of the outcome proposal display 930. The number of votes may be updated each time a vote is made or may be updated only once the whole display is generated or refreshed.

The outcome proposal display 930 may also comprise a status indicator 920 (which may include words, such as “under review”) toward a top of the outcome display or otherwise prominently displayed, so that members can see that the proposed outcome is awaiting acceptance or rejection. While a proposed outcome is under review, further posts can be contributed to the discussion thread 730. The time of proposal and member name of the outcome proposer may be shown within a section 925 of the outcome proposal display 930. The outcome proposal display 930 also includes positive and negative selection options 952, 954 to allow acceptance/approval of the proposed outcome or to reject it. Authorised group members or super users can elect to reject a proposed outcome from another member if it is considered to be inappropriate. Although the member that rejects or accepts an outcome proposal may consider the votes made in the discussion thread and votes cast regarding the proposed outcome, they are not bound to follow such votes, nor the prevailing sentiment of the discussion posts.

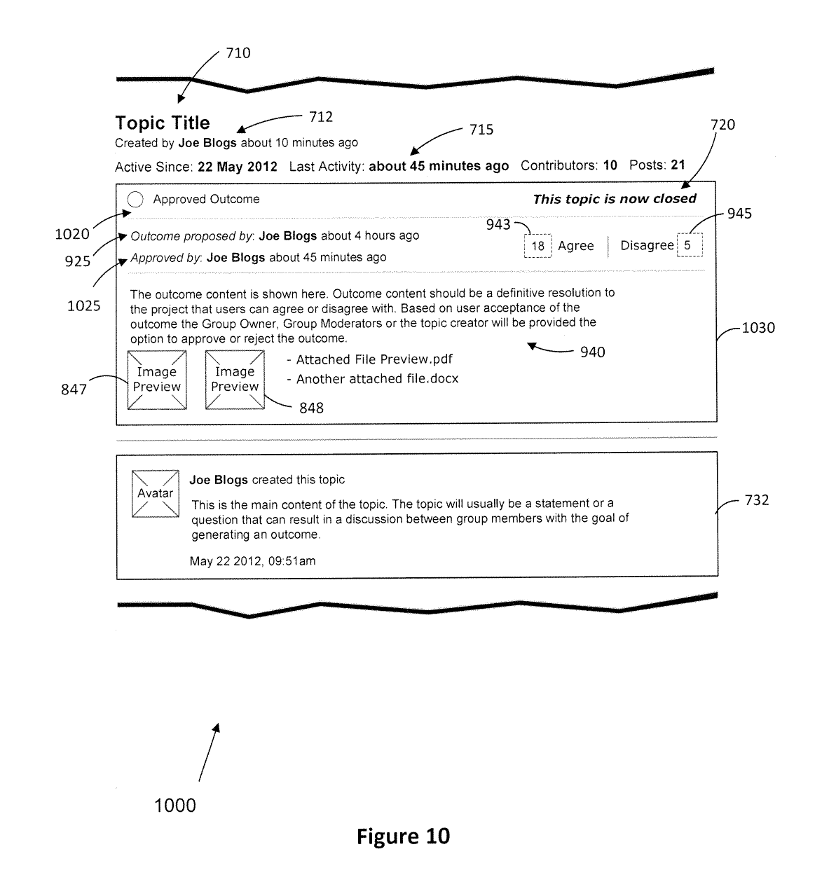

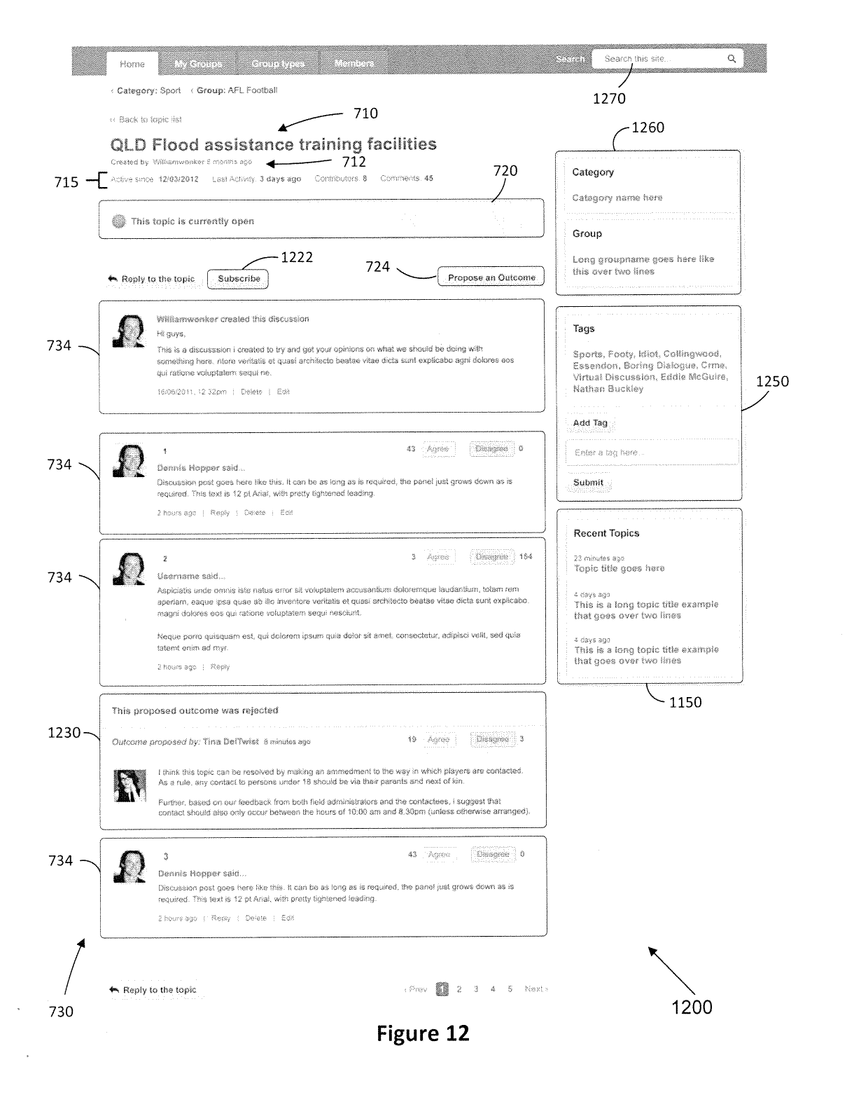

If the proposed outcome is rejected at 560, the rejected proposal is embedded within the discussion thread in chronological order (as shown by rejected proposal 1230 in FIG. 12) and then users may continue to post to the thread and further develop the discussion at 520 until another outcome can be formulated and proposed at 540. Preservation of the rejected outcome within the discussion thread also allows better auditing of the decision making process that (hopefully) leads to an approved outcome. If the proposed outcome is accepted/approved at 570, then an approved outcome display 1030 (FIG. 10) is generated and positioned at the top of the discussion thread and it is recorded as an approved outcome at 580 for later reference and the discussion thread is closed at 590. A closed topic cannot be re-opened.

The approved outcome display 1030 may also comprise a status indicator 1020 (which may include words, such as “Approved Outcome”) toward a top of the approved outcome display 1030 or otherwise prominently displayed, so that members can see that the proposed outcome has been approved. This may be complemented by a status indication 720 that indicates the topic is now closed. The time of approval of the proposal and member name of the outcome approver may be shown within a section 1025 of the outcome proposal display 1030.

Generally, the stored user permissions associated with a user's account will be referenced in generating the page code to be served to browser application 262, so that selectable options for which a user lacks authorisation will not be displayed to that user. For example, a user that is not a member of a group may view the discussion threads under topics for that group but will not be shown options to allow that user to post to discussions in that group or vote. In another example, if a user is not authorised to accept or reject a proposed outcome, then that user will not have such selectable options 952, 954 displayed within outcome proposal display 930. Similarly, if the server system 110 detects that there is no proposed outcome under review for a particular discussion topic, then the “Propose outcome” option 724 is displayed to authorised users.

Although user permissions govern what action a group member can take in relation to proposed outcomes, it is permissible for authorised members that have a moderator role to delegate that role to another group member. That delegation can subsequently be removed. Thus, multiple members, including super users, may act as group moderators for a particular group.

Referring also to FIG. 6, a method 600 of facilitating resolution of an outcome is described in further detail. Method 600 begins at 610, when a timing function detects that a first period of inactivity on a particular topic has elapsed, whereupon the notification functions 315 will issue a prompt by email or possibly other electronic notification forms (such as a text message, SMS, or an alert posted to a user's profile within the on-line collaboration environment 222, for example) to each group member's designated email address or other preferred electronic notification address, alerting the group members to the fact that an outcome has not yet been reached for the discussion thread. This is intended to prompt further discussion and proposal of an outcome if one has not yet been proposed. If an outcome has been proposed, then the notification/prompt is intended to stimulate further discussion that can lead to acceptance or rejection of the proposed outcome or to at least remind authorised members of the group to accept or reject the proposed outcome.

If at 615 there is new activity recorded in relation to a topic, such as a new post or a vote being cast for a post or proposed outcome, then the timing function is reset to zero at 620. Otherwise, if there is no new activity recorded for the topic, then the timing function keeps waiting at 518.

At 630, if the timing function detects that a second period (longer than the first period) of inactivity on the topic has elapsed, the notification functions 315 will issue a further prompt by email or possibly other notification forms (such as an alert posted to a user's profile within the on-line collaboration environment 222) to each group member's designated email address or other preferred electronic notification address, alerting the group members to the fact that an outcome has not yet been reached for the discussion thread. If new activity is subsequently detected at 615, then the timer is reset at 620.

At 640, if the timing function detects that a third period (longer than the second period) of inactivity on the topic has elapsed, the notification functions 315 will issue a further prompt by email or possibly other notification forms (such as an alert posted to a user's profile within the on-line collaboration environment 222) to the group owner, group moderator and topic creator. The notification is sent to the appropriate members' designated email address or other preferred electronic notification address, alerting the group owner, group moderator and topic creator to the fact that an outcome has not yet been reached for the discussion thread and that in a further fourth period of time (optionally shorter than or about the same as the first period of time) the topic will be timed out (closed) if there is no further activity. If new activity is subsequently detected at 615, then the timer is reset at 620.

At 650, if the timing function detects that a fifth period (equal to the sum of the third and fourth period) of inactivity on the topic has elapsed, the notification functions 315 will issue a notification by email or possibly other notification forms (such as an alert posted to a user's profile within the on-line collaboration environment 222) to the group owner, group moderator and topic creator. The notification is sent to the appropriate members' designated email address or other preferred electronic notification address, alerting the group owner, group moderator and topic creator to the fact that an outcome was not reached and the topic has been timed out and closed. A topic thus closed cannot be re-opened.

The first period may be 7 days, the second period may be 14 days, the third period may be 21 days, the fourth period may be 3 days and the fifth period may be 24 days, for example. Such time periods may be configurable by a super user and other time periods may be selected to suit a desired time frame for resolving discussion threads.

A further function of the notification functions 315 is to generate and send to each member a daily (or other regular interval) summary digest of activity recorded in relation to groups to which the member belongs. This summary digest may include posts (or just the first line or few lines of a long post), accepted outcomes, rejected outcomes, newly posted polls, files or articles and other pertinent announcements for members of the on-line collaboration environment.

It is also possible for a user to subscribe to each individual topic (as well as the overall group as mentioned above) where allowed by their user permissions settings. As shown in FIG. 12, a selectable “subscribe” option/button 1222 is shown above the initial post 732 at the top of the displayed discussion thread 730. If a user elects to subscribe to a topic, then the notification functions 315 generate and transmit to that subscribed user an email/notification every time another member posts to the topic

Referring further to FIG. 12, there is shown a display 1200 of a discussion thread 730 including an initial post 732 and subsequent posts 734. The discussion thread 730 includes a rejected outcome display 1230 located among the posts of the discussion thread 730. The rejection outcome display 1230 has a clear indication across the top that the proposed outcome was rejected and includes within a demarcated area of the rejected outcome the text of the outcome as it was proposed, together with the number of positive and negative votes received for the proposed outcome prior to its rejection. Rejected outcomes cannot be voted upon.

Rejected outcome display 1230 thus forms part of the discussion thread 730 and is presented in the visual form of a post, optionally in chronological order among the topic posts. This allows members to review the rejected outcome along with the topic posts when formulating a revised outcome proposal. If the topic subsequently becomes closed, embedding of the rejected outcome display 1230 within the discussion thread 730 allows review and auditing of the discussion and decision making process that occurred prior to the closing of the topic (which may have been because it was timed out or an outcome was approved).

Display 1200 also shows further user interface features to enrich the members' experience of the topic discussion, such as a tag window or display 1250 to list tags parsed or indexed from the text of the discussion posts and any proposed outcomes, as well as a recent topic list display or window 1150 or a topic category display or window 1260. Additionally, display 1200 (and the other displays shown in relation to FIGS. 7 to 11, 13 to 15 and 17) may have a search field 1270 to allow general text searching of groups, topics, outcomes and other activity occurring within the online collaborative environment 222.

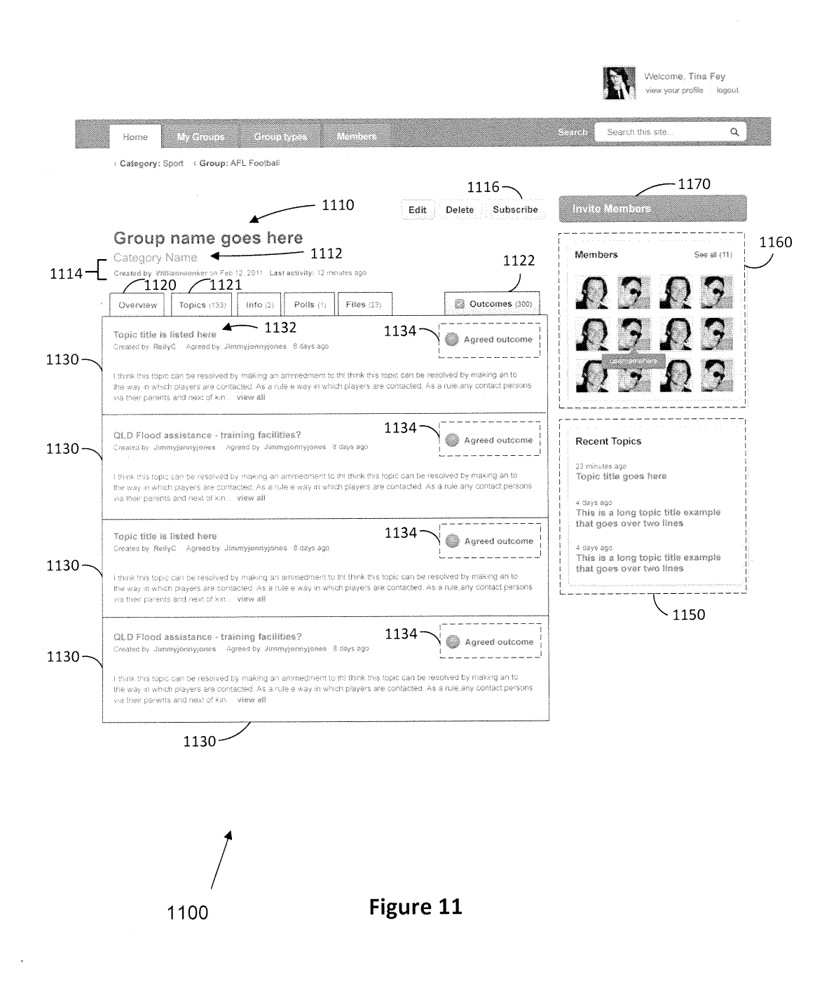

Referring also to FIG. 11, there is shown a display 1100 of a topic list for a particular member group. A group name 1110 for the group is displayed at the top of the page, together with a category name 1112 for the group as well as information 1114 regarding the group creator and recent activity. A display 1130 of recent topics can be accessed by selecting a topics tab 1121 from among various tabs shown toward a top of display 1100. Each of the topic displays 1130 within the list (viewable by selecting topics tab 1121) has a topic summary, including a topic title 1132 and an indication 1134 of the status of the topic, such as whether an outcome for the topic has been agreed, whether the topic is open, an outcome is under review or a proposed outcome has been rejected.

Display 1100 further includes a selectable tab 1122 to view agreed outcomes for topics created by members of the group corresponding to the group name 1110. In some embodiments, the outcomes tab 1122 may, when selected, display (or selectively enable display of) all outcomes, including rejected outcomes and topics that were timed out.

A selectable overview tab 1120 is also displayed at the top of the topic summaries 1130 to allow group members to view an overview of recent group activity, such as is shown by way of example in display 1500 of FIG. 15. Further, display 1100 includes a selectable option 1116 to subscribe to the group having the displayed group name 1110. Depending on the user permissions settings of the member viewing the display 1100, the subscribe option 1116 may not be available.

Display 1100 may also include a member window or display 1160 along one side of display 1100, showing the thumbnail pictures or avatars of the members of the group having group name 1110. Additionally, display 1100 may include a recent topic list window or display 1150 along the side and display 1100, giving viewers of the display 1100 a short summary view of recently posted topics or topics for which recent activity was recorded.

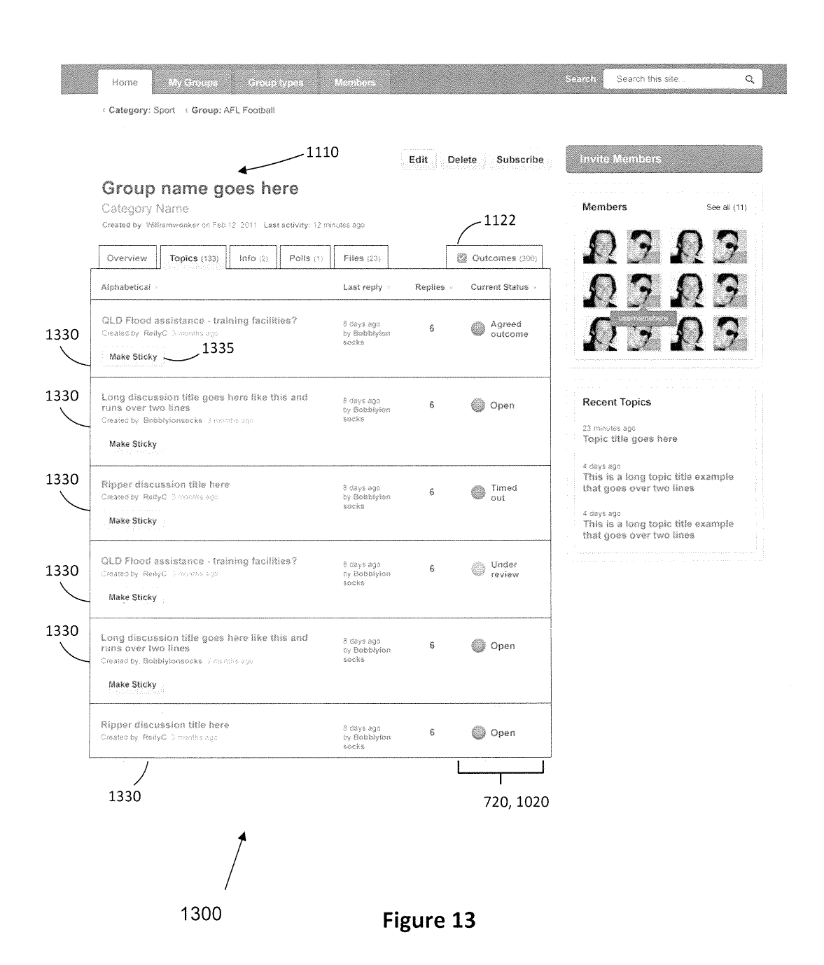

Referring also to FIG. 13, there is shown a display 1300 of a topics list for a group having group name 1110. Display 1300 may be an alternative or additional display to display 1100, including displays of group topics shown in summary form in a chronological (or other) order. The topic list may show status outcomes 720, 1020 or topic statuses such as “open” or “timed out”. Each topic summary may have a selectable option 1335 to prioritize or pin a topic toward the top of the topic list, so that members can more easily view and access topics that are of particular interest.

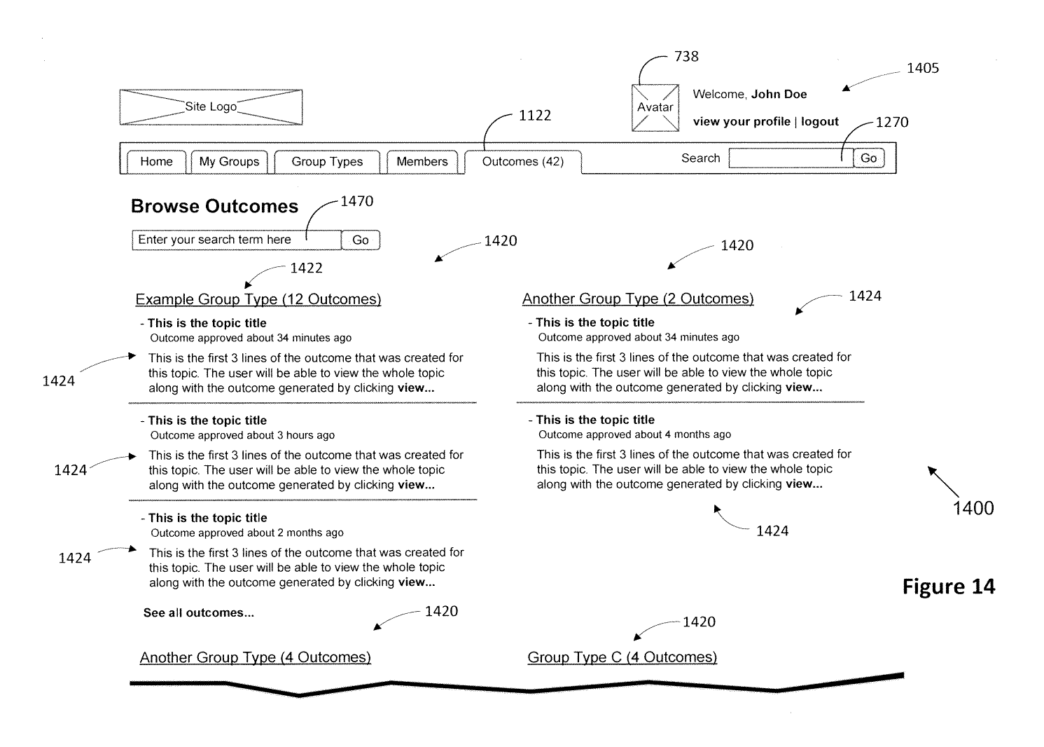

Referring also now to FIG. 14, there is shown a display 1400 to enable browsing of outcomes. Display 1400 is intended to allow a summary view and browsing of agreed outcomes across multiple groups and group types, thus promoting the visibility of outcomes and fostering a sense of productivity and progress among the group members and members of the entire on-line collaborative environment. Display 1400 has group based outcome summaries 1420 displayed according to group types and indicating the number of outcomes 1422 approved in groups of the respective group type. Each group type summary 1420 has example topics 1424 posted by members of groups of that group type that have had an approved outcome.

Display 1400 further includes a search input field 1470 to allow input of key words for searching specifically in relation to outcomes. This searching may be enabled only in respect of approved outcomes or, in some embodiments, may also allow searching of rejected outcomes or proposed outcomes that are under review. Display 1400 also includes a personalized user section 1405 that shows the user's avatar 738 and provides a welcome message to the user viewing the display 1400, plus options to view the users profile and logout of the system. This section 1405 is preferably viewable and/or displayed on each page of the online collaboration environment viewed by each user when logged in.

Referring now to FIG. 15, there is shown a display 1500 of a group homepage for a group of a particular group name 1110 within the online collaboration environment 222. The home page display 1500 includes a display or window 1530 of summaries 1532 of recent group activity by members of the group. The summaries 1532 may be ordered according to selectable filter criteria 1534, such by group, topics, articles, recency or other filter criteria. Each group summary 1532 may include an image of the group member that has contributed to the summarized recent activity shown in the summary 1532, together with a text description of the type of activity, its recency, the topic to which it applied and any related outcomes status 720, 1020.

Each group homepage display 1500 has an overview tab 1120 that includes text 1522 describing something about the group, such as its purpose, members or other relevant description. This text 1522 is included within a group header 1520 that is separate from the recent group activity window or display 1530.

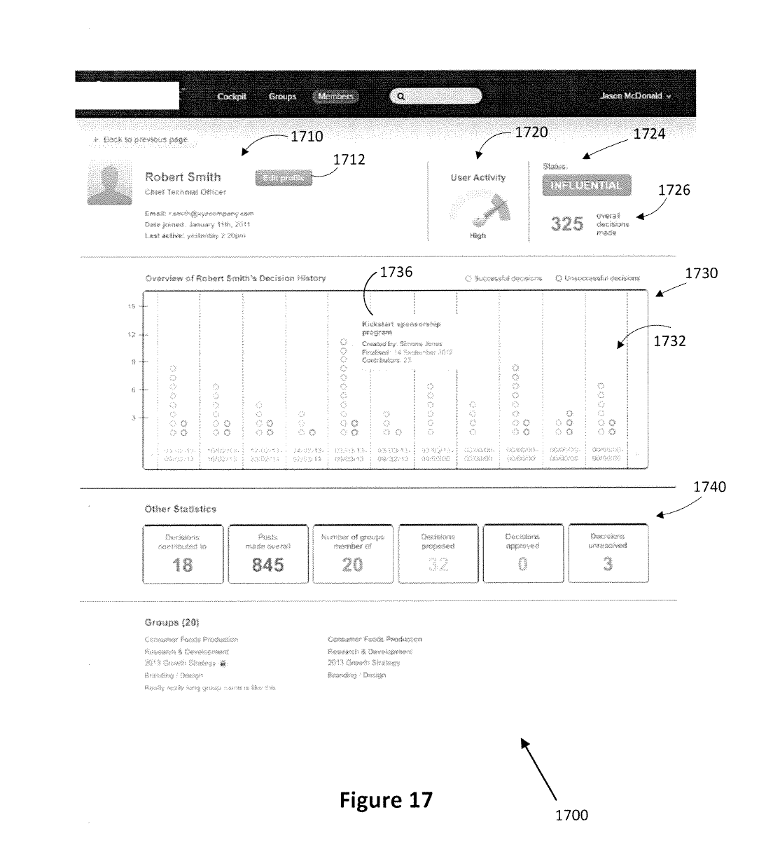

Referring also to FIGS. 16 and 17, example screen displays 1600 and 1700 are shown and described in relation to the determination of member decision-making effectiveness and outcome effectiveness metrics. Display 1600 illustrates an example reporting and analytics screen, which may include several tabbed reporting displays. Such tabbed reporting displays may include a decision makers list accessed by a decision makers tab 1610, a display to illustrate member contribution rates accessed via a contribution rates tab 1611, a display to illustrate outcome deadlines missed by groups or group members accessed via a deadlines missed tab 1612, a display to illustrate deadlines met by groups or group members accessed via a deadlines made tab 1613 and a display to indicate historical timing of outcomes accessed via a decision by time tab 1614.

As shown in display 1600, the display of the decision makers tab 1610 includes a list 1620 of decision makers (ie, those members contributing to outcomes, shown in FIG. 16 as “decisions”). List 1620 may include a numerical ranking with a row for each ranking in the list to indicate a name and/or graphical identifier 1630 of each member appearing in the list. For each such member in the list, a total number of outcomes (decisions) 1632 may be shown, together with a number of those outcomes 1634 that were approved (successful) and a number of those outcomes 1636 that were rejected (unsuccessful). Each listed member of list 1620 may also have a descriptive rating 1640 shown in relation to that member, for example in the form of a graphical and/or descriptive label. Examples of such descriptive labels may include “proficient”, “influential”, “leader”, “rising star”, “competent” and ‘poor”. The rating indications 1640 shown in FIG. 16 do not necessarily correspond with the numbers of approved (1634) verses rejected (1636) outcomes and are provided for illustrated purposes only.

Referring also to FIG. 17, a display 1700 may be accessed in relation to each member to illustrate graphically and/or by display of metrics and statistics derived from the user activity and contributions within the online collaboration environment 222. In the example display 1700, the user summary information 1710 may be provided toward a top of the display, with an option 1712 to edit the member's profile (if authorised). Further, a graphical activity indicator 1720 may be displayed to indicate a relative degree of activity (amount and frequency of contributions) contributed by the member to which the display 1700 relates.

Display 1700 may further comprise a graphical and/or written description of the rating and/or status of the member, for example in the form of a rating or ranking indication 1724. In the example shown in FIG. 1700, the member Robert Smith is shown as having a “high” activity indicator 1720 and a “influential” ranking indicator 1724. Additionally, a numerical indication 1726 (or other equivalent graphical indication) of the absolute or relative number of outcomes made or contributed to by the member may be provided toward a top of display 1700.

Display 1700 may further comprise an overview of the member's decision history 1730, for example in the form of a bar chart, indicating the number of successful and unsuccessful decisions (ie, approved and rejected outcomes) for a number of discrete periods over time (ie, periods and days, weeks, months, or years). Such periods may be demarcated into sections 1732 within a larger time frame which can be discerned by information along the bottom (time axis) of the bar chart 1730. Approved and rejected outcomes may be shown side-by-side for comparison within a particular time period section 1732.

Additionally, each outcome shown in the decision history 1730 may have a graphical element (shown in FIG. 17 as small colored circles, as an example) that can be selected (by mouse-over or clicking, for example) to cause the served code to generate a small display window 1736 as an opaque or semi-transparent overlay adjacent the selected graphical element. The display window 1736 comprises summary details of the outcome corresponding to the selected graphical element, for example including details of the discussion topic or group title in relation to which the outcome was accepted or rejected, optionally including details of the outcome proposer, the date on which the outcome was accepted or rejected and the number of contributions made by group members to the outcome or just the number of contributions made by the member whose decision history is being viewed (displayed) in display 1700.

Display 1700 may further comprise other statistics 1740 that may be indicative of the level and/or effectiveness of the member's contributions within the online collaboration environment 222. For example, the statistics 1740 may include a numerical or graphical indication of outcomes contributed to, total number of posts or comments made in group discussions, the number of groups that the member belongs to, the number of outcomes proposed, the number of outcomes approved and/or the number of outcomes unresolved.

Advantageously, described embodiments not only enable greater organisational focus on the generation of outcomes (decisions), but described embodiments also enable the effectiveness of such outcomes and contributors to those outcomes (including proposers) to be assessed, thereby allowing outstanding team members to be more readily identified and publicly recognised.

Embodiments are described herein by way of example, with reference to the drawings. The embodiments are intended to be provided by way of non-limiting example and some modifications of the described embodiments may be apparent to those of ordinary skill in the art without departing from the spirit and scope of the embodiments.

The claimed invention is:

1. An on-line collaboration system, comprising:
at least one server in communication with multiple client devices over one or more networks, the at least one server executing program code to host an on-line collaborative environment in which users of the client devices can collaborate;
wherein the at least one server executes program code to facilitate discussion threads in the on-line collaborative environment and, for each discussion thread, to provide a selectable option to allow proposal of an outcome for the discussion thread.

2. The system of claim 1, wherein, in response to receipt of a proposed outcome, the at least one server executes program code to allow voting selections to be received from client devices in relation to the proposed outcome.

3. The system of claim 2, wherein the voting selections consist of a positive vote selection and a negative vote selection.

4. The system of claim 3, wherein the at least one server executes further code to display the number of positive vote selections received and the number of negative vote selections received in relation to the proposed outcome.

5. The system of claim 2, wherein the at least one server executes further program code to allow receipt of an acceptance selection or a rejection selection in relation to a proposed outcome.

6. The system of claim 5, wherein the at least one server has access to stored user permission data specifying a permission level for each user in relation to the proposed outcome, wherein the at least one server allows receipt of the acceptance selection or the rejection selection in relation to the proposed outcome only when the acceptance or rejection selection is received from a client device authenticated with an appropriate permission level.

7. The system of claim 1, wherein the at least one server executes further code to display a current outcome status for each proposed outcome.

8. The system of claim 7, wherein the current outcome status consists of a pending status and a closed status.

9. The system of claim 8, wherein the closed status consists of an accepted status and a rejected status.

10. The system of claim 1, wherein the at least one server executes further code to display on each client device a list of proposed outcomes for a user group to which a user of the client device belongs.

11. In an on-line collaborative environment, a method comprising:
hosting at least one discussion thread; and
providing a selectable option to allow proposal of an outcome for the at least one discussion thread.

12. The method of claim 11, further comprising, in response to receipt of a proposed outcome, allowing voting selections to be received from client devices in relation to the proposed outcome.

13. The method of claim 12, wherein the voting selections consist of a positive vote selection and a negative vote selection.

14. The method of claim 13, further comprising serving code to display the number of positive vote selections received and the number of negative vote selections received in relation to the proposed outcome.

15. The method of claim 12, further comprising serving code to allow receipt of an acceptance selection or a rejection selection in relation to a proposed outcome.

16. The method of claim 15, further comprising allowing receipt of the acceptance selection or the rejection selection in relation to the proposed outcome only when the acceptance or rejection selection is received from a client device authenticated with an appropriate permission level.

17. The method of claim 11, further comprising serving code to display a current outcome status for each proposed outcome.

18. The method of claim 17, wherein the current outcome status consists of a pending status and a closed status.

19. The method of claim 18, wherein the closed status consists of an accepted status and a rejected status.

20. The method of claim 11, further comprising serving code to display on each client device a list of proposed outcomes for a user group to which a user of the client device belongs.

21. A server-hosted on-line collaborative environment that allows proposed discussion outcomes to be received and posted in response to receipt of an outcome proposal selection.

22. A method for on-line collaboration, comprising:
allowing selection of an option to propose an outcome in relation to a discussion thread.

23. The method of claim 22, further comprising, in response to selection of the option to propose an outcome, serving code to display an outcome proposal window that allows preparation and submission of an outcome proposal.

24. The method of claim 23, further comprising, in response to receiving an outcome proposal, serving code to display the outcome proposal in relation to the discussion thread.

25. The method of claim 24, wherein the displayed outcome proposal includes selectable voting options to reject or accept the proposed outcome.

26. The method of claim 25, further comprising, in response to receiving selections of the selectable voting options, recording the selections in a data store and, in a subsequent display of the outcome proposal, displaying an indication of a number of acceptance selections and rejection selections received in relation to the outcome proposal.

27. The method of claim 22, wherein the discussion thread includes at least one discussion post and a discussion header.

28. The method of claim 23, further comprising serving code to display to only an authorised user a selectable option to accept or reject the outcome proposal.

29. The method of claim 28, further comprising, in response to receipt of a selection to accept the outcome proposal, posting the accepted outcome in relation to the discussion thread and disallowing further discussion posts in relation to the discussion thread.

30. The method of claim 28, further comprising, in response to receipt of a selection to reject the outcome proposal, posting the rejected outcome in relation to the discussion thread and allowing further discussion posts in relation to the discussion thread.

31. A method of on-line collaboration, comprising:
allowing a discussion thread to be initiated by a member of a group of users;
allowing proposal of an outcome of the discussion; and
sending a prompt to at least one member of the group to propose an outcome of the discussion if an outcome has not been proposed within a set time.

32. The method of claim 31, wherein the set time is a time elapsed since a most recent post in the discussion thread.

33. The method of claim 31, wherein the set time is a time elapsed since initiation of the discussion thread.

34. The method of claim 31, wherein the prompt is sent to one or more moderators of the group.

35. The method of claim 31, wherein proposal of an outcome of the discussion is only permitted to be made by one or more authorised members of the group.

36. The method of claim 31, wherein the group is a sub-group of the users participating in the on-line collaboration.

37. A method of on-line collaboration, comprising:
allowing proposal of an outcome of a discussion thread, the discussion thread being accessible to a defined group of users;
receiving a voting selection made by each member of the defined group of users in relation to a proposed outcome.

38. The method of claim 37, further comprising serving code to display a selectable positive voting option and a selectable negative voting selection.

39. The method of claim 37, further comprising serving code to display the proposed outcome at a head of the discussion thread.

40. The method of claim 37, further comprising serving code to display a current vote count in relation to the proposed outcome, the vote count representing the number of voting selections receive in relation to the proposed outcome.

41. The method of claim 40, wherein the vote count comprises a positive vote count and a negative vote count corresponding to receiving positive voting selections and negative voting selections.

42. The method of claim 37, further comprising receiving a rejection selection or an acceptance selection in relation to the proposed outcome.

43. The method of claim 11, further comprising in response to acceptance or rejection of the proposed outcome, archiving the outcome as an accepted outcome or a rejected outcome and subsequently allowing review of a rejected or accepted outcome and the related discussion thread.

44. The method claim 11, further comprising, in response to acceptance of a proposed outcome, migrating the accepted outcome to an outcome repository that is accessible to users other than members of a member group that conducted the discussion thread.

45. Computer-readable storage storing executable program code to perform or enable performance of the method of claim 11.

46. The method of claim 11, wherein each discussion thread is hosted in relation to a member group, the member group being a subset of all members participating in the on-line collaborative environment, and wherein only authorised members of each member group are permitted to select the selectable option to allow proposal of the outcome.

47. The method of claim 46, further comprising, for each member of a member group, recording all contributions of the member in relation to the at least one discussion thread.

48. The method of claim 47, wherein each member is eligible to participate in multiple member groups of a specified group type.

49. The method of claim 48, further comprising allowing acceptance or rejection of the proposed outcome for each at least one discussion thread and recording in a data store all posts and votes received from group members in relation to the proposed outcome.

50. The method of claim 49, further comprising, for an accepted outcome, requesting feedback on the outcome from contributors to the discussion thread in relation to which the outcome was accepted, wherein the requesting feedback is performed within the on-line collaborative environment after a predetermined period from when the outcome was accepted.

51. The method of claim 51, wherein the requesting feedback comprises requesting an indication of whether the outcome was a good outcome or a bad outcome.

52. The method of claim 46, further comprising determining metrics of a decision-making effectiveness for each group member.

53. The method of claim 46, further comprising determining metrics of a decision-making effectiveness for each member group.

54. The method of claim 46, further comprising determining metrics of a decision-making effectiveness across all members participating in the on-line collaborative environment.
